(19) United States
(12) Patent Application Publication
(10) Pub. No.: US 2006/0239136 A1
(43) Pub. Date: Oct. 26, 2006

(54) Optical reading apparatus

(75) Inventors: Jen-Yu Hsu, Hsinchu (TW); Hsiang-Yi Fu, Hsinchu (TW); Fu-Hsiang Chen, Hsinchu (TW); Ming-Hsiao Tsai, Hsinchu (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Lite-On It Corp.

(21) Appl. No.: 11/406,618

(22) Filed: Apr. 19, 2006

(30) Foreign Application Priority Data
Apr. 26, 2005 (TW) 094113292

(51) Int. Cl. G11B 7/00

(52) U.S. Cl. 369/44.12

(57) ABSTRACT

In an optical reading apparatus, a light source, a high frequency modulator IC and a first resistor are integrated in an optical pickup unit, wherein the light source emits a light beam onto the optical storage medium in order to read information from the optical storage medium, the high frequency modulator generates a high frequency modulating signal for adjusting the intensity of the light beam, and the first resistor has a first end coupled to ground and a second end couple to a first pin of the high frequency modulator IC. A voltage control module disposed outside the optical pickup unit and coupled to the first resistor in parallel is used for adjusting an output current of the first pin in response to a voltage change thereof, thereby adjusting the amplitude of the high frequency modulating signal.

### FIELD OF THE INVENTION

The present invention relates to an optical reading apparatus such as an optical disc drive, and more particularly to an optical reading apparatus adopting high frequency modulation.

### BACKGROUND OF THE INVENTION

FIG. 1 shows an optical pickup unit (OPU) of a typical optical disc drive. A light beam emitted from a laser diode 10 is focused on the surface of an optical disk 1 through an optical system 11 including a set of lens and mirrors. The reflected light beam from the optical disk 1 through the optical system 11 is converted to an electronic signal by a photodiode 12. The incident and reflective light paths in the OPU of FIG. 1 are separately shown in the FIG. 2(a) and 2(b). As shown in FIG. 2(a), the incident light beam is emitted from the laser diode 10 and transmitted through the optical system 11 to reach the surface of the optical disk 1. Afterwards, as shown in FIG. 2(b), the light beam carrying information of the optical disc 1 is reflected from the surface of the optical disk 1 and transmitted through the optical system 11 to the photodiode 12 to be analyzed. As clearly shown in FIG. 1, there is an overlapping portion between the incident and reflective optical paths so as to likely cause undesired interference between the incident light beam and the reflected light beam. Therefore, the resulting electronic signal generated by the photodiode 12 would be adversely affected by the interference and the data reading/writing accuracy would thus be deteriorated.

For this reason, high frequency modulation (HFM) technology is developed for minimizing the interference effect of the incident light beam on the reflected light beam. According to the HFM technology, a high frequency modulating signal is superimposed to the driving current of the laser diode 10 to differentiate the light beams. For implementing the HFM technology, a high frequency modulator integrated circuit 3 as shown in FIG. 3(a) is used. Since the HFM technology has been widely used, there is no need to go into details herein.

However, the HFM technology is likely to cause some problems. For example, referring to FIG. 3(a), the amplitudes of the high-frequency modulating signals are adjusted according to the resistance values of the external resistors Ramp1 and Ramp2 connected separately to pin numbers 15 and 16 of the IC 3. Also, the frequencies of the high-frequency modulating signals are adjusted according to the resistance values of the external resistors Rfreq1 and Rfreq2 connected separately to pin numbers 2 and 3 of the IC 3. Therefore, driving currents superimposing high-frequency modulating signals with adjustable amplitude and frequency are outputted from pin numbers 18 and 13 to the laser diodes LD1 and LD2. In general, the amplitude of the high-frequency modulating signal decreases with the increase of the resistance coupled thereto. For enhancing data-reading accuracy, a high-frequency modulating signal with high amplitude is desirable. Unfortunately, the higher the amplitude of high frequency modulation signal is, the more significant the electromagnetic interference (EMI) of the optical disc drive is. Accordingly, the high-frequency modulating signal with too high amplitude would cause the optical disc drive fails in the EMI test. Therefore, the designer has to select and mount suitable external resistors in order to adjust the amplitudes of the high frequency modulation signals within an optimal range, which may require replacement of external resistors again and again.

As the high-frequency modulator IC 3 and the resistors are all disposed inside the optical pickup unit of the optical disc drive. The process of replacing resistors would be too complicated to be cost- and laboring-efficient.

FIG. 3(b) shows the frequency spectrum of the high frequency modulation signal outputted by the IC 3 of FIG. 3(a), which is centralized around a certain frequency, e.g. about 300 MHz for a CD laser and about 350 MHz for a DVD laser. In addition to high amplitude, the highly centralized feature of the high frequency modulation signal also intensifies the EMI effect.

### SUMMARY OF THE INVENTION

Therefore, an object of the present invention is to design an optical reading apparatus for conveniently adjusting the amplitude of the high frequency modulating signal so as to reduce the EMI effect and thus improve the data-reading quality.

Another object of the present invention is to design an optical reading apparatus for well distributing the frequency of the high frequency modulating signal so as to reduce the EMI effect and thus improve the data-reading quality.

The present invention provides an optical reading apparatus for reading an optical storage medium. The optical reading apparatus comprises an optical pickup unit integrated therein a light source, a high frequency modulator IC and a first resistor, wherein the light source emits a light beam onto the optical storage medium in order to read information from the optical storage medium, the high frequency modulator generates a high frequency modulating signal for adjusting the intensity of the light beam, and the first resistor has a first end coupled to ground and a second end couple to a first pin of the high frequency modulator IC. The optical reading apparatus further comprises a voltage control device coupled to the first resistor in parallel for adjusting an output current of the first pin in response to a voltage change thereof, thereby adjusting the amplitude of the high frequency modulating signal. The voltage control device can be a voltage control module disposed outside the optical pickup unit.

In an embodiment, the voltage control device comprises a register for storing a digital data that is mapped to a voltage value; a digital-to-analog converter coupled to the register for converting the digital data to the voltage value; an amplifying circuit coupled to the digital-to-analog converter for receiving the voltage value and generating and outputting a corresponding current; and an output resistor coupled between the amplifying circuit and the second end of the first resistor in series, and flowing therethough the current outputted by the amplifying circuit. The summation of the output current of the first pin and the current flowing through the output resistor is equal to the current flowing through the first resistor, which is a constant.

In another embodiment, the voltage control module comprises a variable voltage source for outputting a variable voltage value; and an output resistor coupled between the variable voltage source and the second end of the first resistor in series, wherein the output current of the first pin changes with the current flowing through the output resistor.

In an embodiment, the optical reading apparatus further comprises a second resistor integrated in the optical pickup unit and coupled to a second pin of the high frequency modulator IC; and an AC voltage source grounded by one end thereof and coupled to the second pin of the high frequency modulator IC in parallel to the second resistor by another end thereof for dispersing the frequency of the high frequency modulating signal.

The present invention also provides an optical reading apparatus for reading an optical storage medium, which comprises an optical pickup unit integrated therein a light source, a high frequency modulator IC and a first resistor, wherein the light source emits a light beam onto the optical storage medium in order to read information from the optical storage medium, the high frequency modulator generates a high frequency modulating signal for adjusting the intensity of the light beam, and the first resistor has a first end grounded and a second end couple to a first pin of the high frequency modulator IC; and a voltage control module disposed outside the optical pickup unit and coupled to the first resistor in parallel for adjusting an output current of the first pin in response to a voltage change thereof, thereby adjusting the amplitude of the high frequency modulating signal. The optical reading apparatus can further comprise a second resistor integrated in the optical pickup unit and coupled to a second pin of the high frequency modulator IC; and an AC voltage source grounded by one end thereof and coupled to the second pin of the high frequency modulator IC in parallel to the second resistor by another end thereof for dispersing the frequency of the high frequency modulating signal. The voltage change of the voltage control module can be conducted from the external.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic block diagram showing an optical pickup unit (OPU) of an optical disc drive;

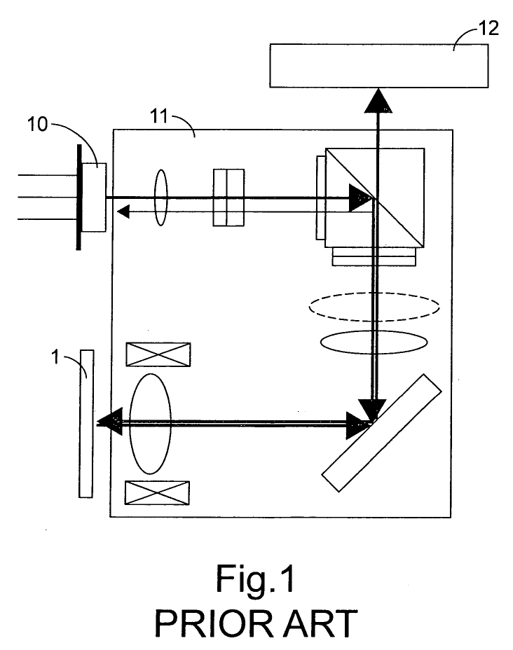

FIG. 2(a) is a schematic block diagram showing the optical path of the incident light beam in the optical pickup unit;

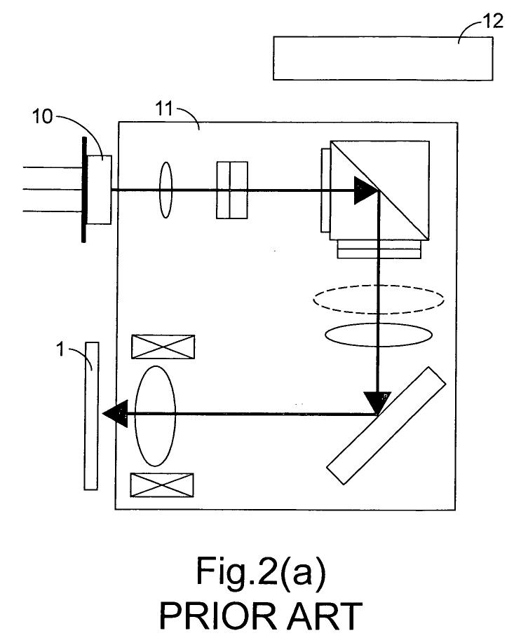

FIG. 2(b) is a schematic block diagram showing the optical path of the reflected light beam in the optical pickup unit;

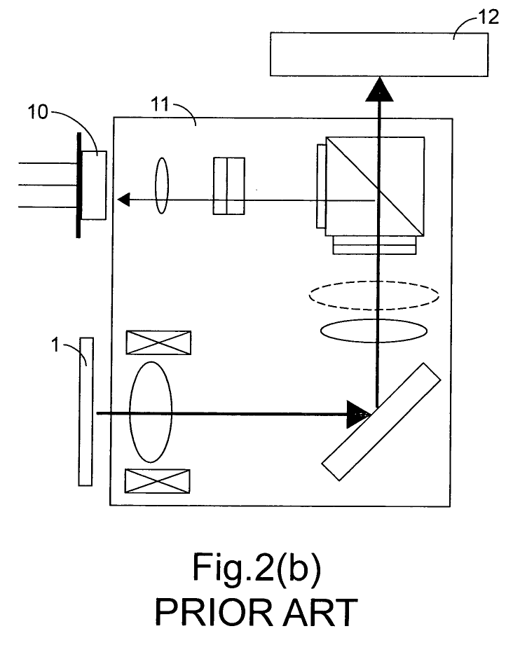

FIG. 3(a) is a circuit layout and pin list of a high-frequency modulator IC and circuitry coupled thereto according to prior art;

FIG. 3(b) is a schematic frequency spectrum of a high frequency modulation signal outputted by the high-frequency modulator IC of FIG. 3(a);

FIG. 4 is a circuit layout of a high-frequency modulator IC disposed in an optical pickup unit and associated circuitry according to an embodiment of the present invention;

FIG. 5 is a schematic circuit block diagram illustrating an embodiment of the voltage control module according to the present invention;

FIG. 6 a schematic circuit block diagram illustrating another embodiment of the controller voltage-source module according to the present invention;

FIG. 7 is a circuit layout of a high-frequency modulator IC disposed in an optical pickup unit and associated circuitry according to another embodiment of the present invention; and

FIG. 8 is a schematic frequency spectrum of a high frequency modulation signal outputted by the high-frequency modulator IC of FIG. 7.

### DETAILED DESCRIPTION OF THE PREFERRED EMBODIMENT

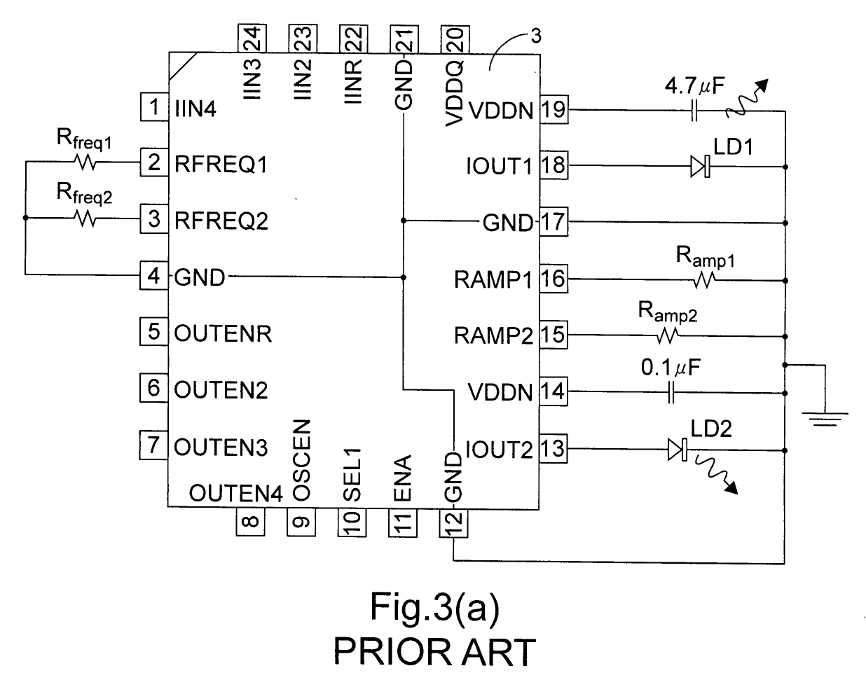

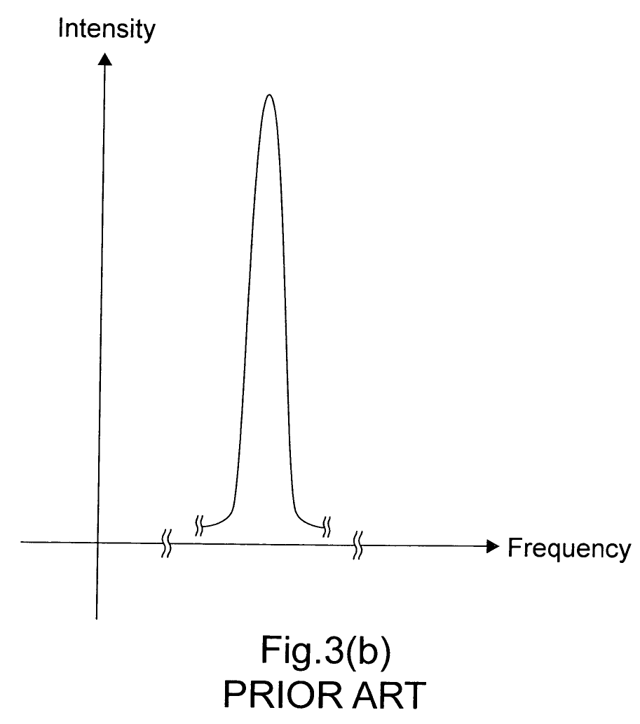

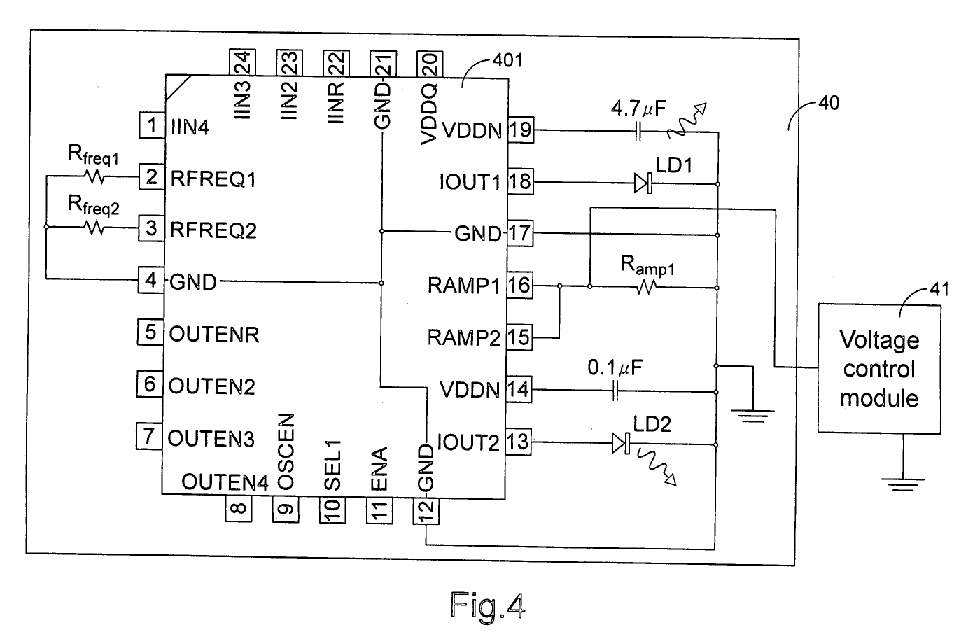

In an embodiment of an optical reading apparatus shown in FIG. 4, the circuitry coupled to a high-frequency modulator IC 401 similar to the high-frequency modulator IC 3 of FIG. 3(a) includes laser diodes LD1 and LD2 coupled to both pin numbers 18 and 13 of the IC 401, a resistor Ramp1 coupled to both pin numbers 15 and 16 of the IC 401, and a voltage control module 41 coupled to pin numbers 15 and 16 of the IC 401 in parallel to the resistor Ramp1 but disposed outside the optical pickup unit 40. Laser diodes LD1 and LD2 are used as light sources for emitting laser beams with different wavelength to read different kinds of optical discs, e.g. CD and DVD, respectively. The intensity of the light beam emitted by laser diode LD1 or LD2 is adjusted by superimposing a high-frequency modulation signal outputted by the IC 401 on the driving current of the laser diode LD1 or LD2. Since the voltage control module 41 is coupled to the node of pin numbers 15 and 16, the output current via pin numbers 15 and 16 can be adjusted by having the voltage thereof changed. Furthermore, since the voltage control module 41 is located outside the optical pickup unit 40, the voltage thereof can be easily adjusted without changing elements inside the optical pickup unit 40. In this way, the amplitude of the high frequency modulation signal can be adjusted easily.

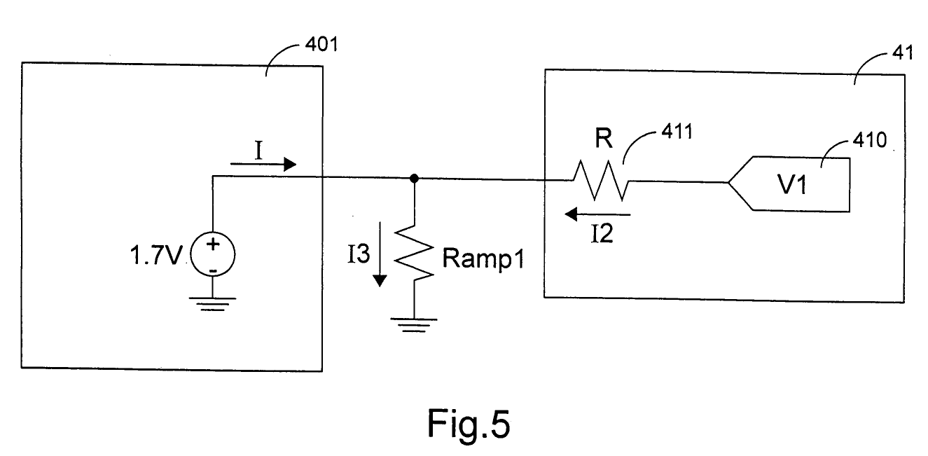

An embodiment of the voltage control module 41 according to the present invention is illustrated in FIG. 5. The voltage control module 41 consists of a variable voltage source 410 and an output resistor 411. The variable voltage source 410 provides a V1 voltage to the output resistor 411. The output resistor 411 is connected between the variable voltage source 410 and the non-grounded end of the resistor Ramp1 for supplying an output current I2. The current I3 flowing through the resister Ramp1 is equal to the summation of the current I outputted from the high-frequency modulator IC 401 and the output current I2 resulting from the controlled voltage. Since the source voltage inside the high-frequency modulator IC 401 is constant, e.g. 1.7V, so the current I3 flowing through the resistor Ramp1 is also constant. Accordingly, when the voltage (V1) outputted from the variable voltage source 410 increases, the output current I2 also increases, and thus the current I decreases so as to keep the current I3 constant. In other words, the decrease of the current I can be accomplished by raising the voltage V1. As understood, the decrease of the current I will result in the reduction of the amplitude of the high-frequency modulation signal, thereby alleviating the EMI effect. Depending on different optical storage media such as CD and DVD, optimal amplitudes of the high-frequency modulating signal can be obtained by essentially adjusting the voltage of the voltage control module instead of changing resistors as in the prior art.

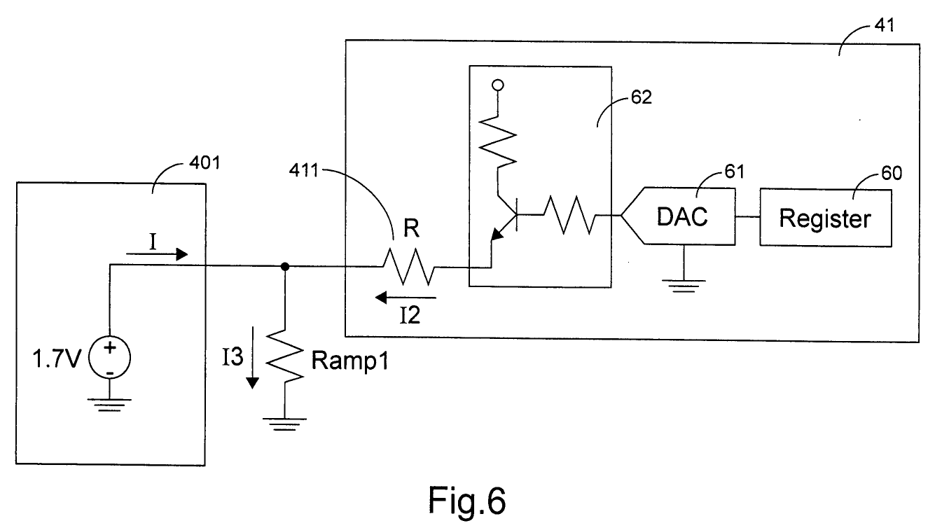

FIG. 6 shows another embodiment of the voltage control module 41 according to the present invention. The voltage control module 41 includes a register 60, a digital-to-analog converter (DAC) 61 and a amplifying circuit 62. The register 60 stores therein a digital data that can be mapped to a certain voltage value. The DAC 61 connected to the register 60 converts the digital data to a specific voltage. The amplifying circuit 62 generates a specific current according to the specific voltage and outputs the specific current to the resistor 411. In this way, the amplitude of the high-frequency modulation signal can be adjusted by rewriting the digital data stored in the register 60, thereby alleviating the EMI effect.

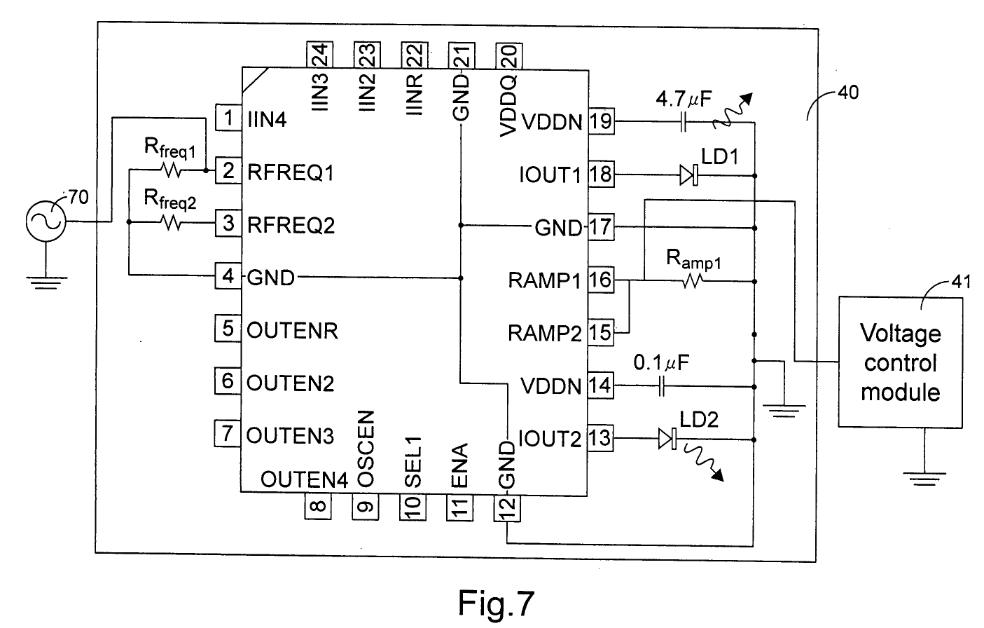

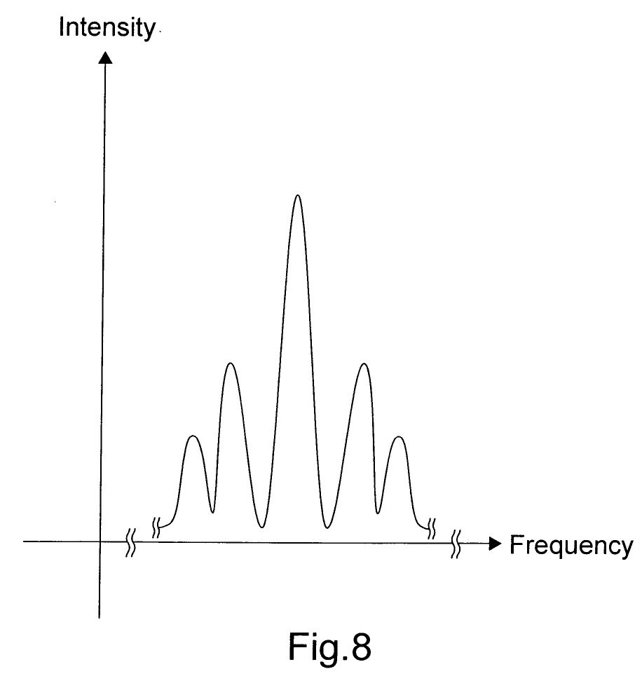

In addition to adjusting the amplitude of the high-frequency modulation signal, the EMI effect can be ameliorated according to the present invention by properly dispersing the centralized frequency of the high-frequency modulation signal. A circuitry capable of achieving this purpose is exemplified in FIG. 7. In this embodiment, an AC voltage source 70 is disposed outside the optical pickup unit but coupled to pin number 2 in parallel to the resistor Rfreq1 for adjusting the frequency of the high-frequency modulating signal that will be superimposed on the driving current of LD1. Alternatively, the AC voltage source can be coupled to pin number 3 in parallel to the resistor Rfreq2 for adjusting the frequency of the high-frequency modulating signal that will be superimposed on the driving current of LD2. For example, the frequency of the AC voltage source can be a triangle or a sinusoidal wave having frequency of about 50 KHz, and the resulting frequency distribution of the high-frequency modulating signal is dispersed as shown in FIG. 8. With the proper distribution of the frequency of the high-frequency modulating signal, the EMI effect can be alleviated.

The voltage control module as illustrated in the embodiment of FIG. 4 and the AC voltage source as illustrated in the embodiment of FIG. 7, although both exemplified to be disposed outside the optical pickup head in order to modify voltage from the external, can also be alternative circuitry completely or partially incorporated into the optical pickup unit as long as the adjustment of the voltage can be easily achieved, for example in a signal control manner.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical reading apparatus for reading an optical storage medium, comprising:
an optical pickup unit integrated therein a light source, a high frequency modulator IC and a first resistor, wherein the light source emits a light beam onto the optical storage medium in order to read information from the optical storage medium, the high frequency modulator generates a high frequency modulating signal for adjusting the intensity of the light beam, and the first resistor has a first end coupled to ground and a second end couple to a first pin of the high frequency modulator IC; and
a voltage control device coupled to the first resistor in parallel for adjusting an output current of the first pin in response to a voltage change thereof, thereby adjusting the amplitude of the high frequency modulating signal.

2. The optical reading apparatus according to claim 1 wherein the light source is a laser diode.

3. The optical reading apparatus according to claim 1 wherein the voltage control device is a voltage control module disposed outside the optical pickup unit.

4. The optical reading apparatus according to claim 1 wherein the voltage control device comprises:
a register for storing a digital data that is mapped to a voltage value;
a digital-to-analog converter coupled to the register for converting the digital data to the voltage value;
an amplifying circuit coupled to the digital-to-analog converter for receiving the voltage value and generating and outputting a corresponding current; and
an output resistor coupled between the amplifying circuit and the second end of the first resistor in series, and flowing therethough the current outputted by the amplifying circuit.

5. The optical reading apparatus according to claim 4 wherein the summation of the output current of the first pin and the current flowing through the output resistor is equal to the current flowing through the first resistor.

6. The optical reading apparatus according to claim 5 wherein the current flowing through the first resistor is constant.

7. The optical reading apparatus according to claim 1 wherein the voltage control module comprises:
a variable voltage source for outputting a variable voltage value; and
an output resistor coupled between the variable voltage source and the second end of the first resistor in series,
wherein the output current of the first pin changes with the current flowing through the output resistor.

8. The optical reading apparatus according to claim 7 wherein the summation of the output current of the first pin and the current flowing through the output resistor is equal to the current flowing through the first resistor.

9. The optical reading apparatus according to claim 8 wherein the current flowing through the first resistor is constant.

10. The optical reading apparatus according to claim 1 further comprising:
a second resistor integrated in the optical pickup unit and coupled to a second pin of the high frequency modulator IC; and
an AC voltage source grounded by one end thereof and coupled to the second pin of the high frequency modulator IC in parallel to the second resistor by another end thereof for dispersing the frequency of the high frequency modulating signal.

11. The optical reading apparatus according to claim 10 wherein the AC voltage source is disposed outside the optical pickup unit.

12. The optical reading apparatus according to claim 1 wherein the first resistor is simultaneously coupled to two pins of the high frequency modulator IC.

13. The optical reading apparatus according to claim 1 wherein the light source is DVD laser or a CD laser.

14. An optical reading apparatus for reading an optical storage medium, comprising:
an optical pickup unit integrated therein a light source, a high frequency modulator IC and a first resistor, wherein the light source emits a light beam onto the optical storage medium in order to read information from the optical storage medium, the high frequency modulator generates a high frequency modulating signal for adjusting the intensity of the light beam, and the first resistor has a first end grounded and a second end couple to a first pin of the high frequency modulator IC; and
a voltage control module disposed outside the optical pickup unit and coupled to the first resistor in parallel for adjusting an output current of the first pin in response to a voltage change thereof, thereby adjusting the amplitude of the high frequency modulating signal.

15. The optical reading apparatus according to claim 14 further comprising:
a second resistor integrated in the optical pickup unit and coupled to a second pin of the high frequency modulator IC; and
an AC voltage source grounded by one end thereof and coupled to the second pin of the high frequency modulator IC in parallel to the second resistor by another end thereof for dispersing the frequency of the high frequency modulating signal.

16. The optical reading apparatus according to claim 15 wherein the voltage change of the voltage control module is conducted from the external.
